(19) United States
(12) Patent Application Publication
(10) Pub. No.: US 2011/0253788 A1
(43) Pub. Date: Oct. 20, 2011

(54) MONITORING CURRENT LEVEL AND CURRENT INTO AND OUT OF THE ICC READER POWER CONTACTS TO DETECT A PARASITIC SHIM

(76) Inventors: Andrew Campbell, Canterbury (GB); Brian Docherty, Sketty (GB); James Churchman, Llysworney (GB); Kevin Maidment, Panllyn (GB); Nick McGarvey, Whiteway Hill (GB)

(21) Appl. No.: 13/087,562

(22) Filed: Apr. 15, 2011

Related U.S. Application Data
(60) Provisional application No. 61/325,291, filed on Apr. 17, 2010.
(60) Provisional application No. 61/325,289, filed on Apr. 17, 2010.
(60) Provisional application No. 61/325,300, filed on Apr. 17, 2010.
(60) Provisional application No. 61/325,327, filed on Apr. 18, 2010.
(60) Provisional application No. 61/331,432, filed on May 5, 2010.

(51) Int. Cl. G06K 7/06

(52) U.S. Cl. 235/441

(57) ABSTRACT

The present invention detects the current flowing through the contacts of the smart card reader due to the presence of a “shim”. Small value resistors are connected in series with either the Power connection or the Ground connection, or both. Values are typically 47 milliohms to 100 milliohms. The use of such small values ensures that little voltage is dropped across the resistors and that the card is therefore adequately powered. With no card present, the current through these resistors should be zero and therefore the voltage across the resistors will also be zero. Amplifier circuits are employed to monitor and amplify the voltage across the resistors and in the “PayPod” design the amplifier outputs are connected to analogue to digital inputs on the microprocessor. Where the microprocessor (or other processing electronics) used has no analogue to digital inputs, separate analogue to digital circuits may be used. The microprocessor may then monitor the current flowing into the power supply contacts of the card reader.

### CROSS-REFERENCE TO RELATED APPLICATIONS

The present application claims priority from Provisional U.S. Patent Application Ser. No. 61/325,291, filed on Apr. 17, 2010, and incorporated herein by reference.

The subject matter of the present application is also related to the following Provisional U.S. Patent Applications, all of which are incorporated herein by reference:

Ser. No. 61/325,289, filed on Apr. 17, 2010 (DAMALAK-0002P);

Ser. No. 61/325,291, filed on Apr. 17, 2010 (DAMALAK-0003P);

Ser. No. 61/325,300, filed on Apr. 17, 2010 (DAMALAK-0004P);

Ser. No. 61/325,327, filed on Apr. 18, 2010 (DAMALAK-0005P); and

Ser. No. 61/331,432, filed on May 5, 2010 (DAMALAK-0006P).

### FIELD OF THE INVENTION

The present invention relates to Point of Sale Credit Card and Payment Terminals. In particular, the present invention is directed toward improved security for Point of Sale Credit Card and Payment Terminals.

### BACKGROUND OF THE INVENTION

In a card payment terminal, serial data is exchanged between the card inserted in the reader slot of the terminal and the processing electronics within the terminal (e.g., the microprocessor). The card, in this instance, may be a so-called “smart card” with an embedded microprocessor or the like. Generally, card payment terminals are designed to detect attempts to open or otherwise tamper with them in order to intercept data exchanged between the card and the processing electronics (generally a microprocessor). Fraudsters may go to great lengths to tamper with or modify card terminal apparatus. If a terminal can be modified in such a way that signals can be intercepted and routed out of the terminal in such a way as to be invisible or at least not obvious to a user then the chances of obtaining private data for fraudulent use are increased.

One method used is to try to insert what is known as a “shim” between the card reader terminals and the card such that data is intercepted between the card reader contacts and the card itself. Having done that, data can be extracted by leading wires out of the terminal via the card slot or otherwise. Such wires ought to be visible to a wary user. Alternatively, circuitry could be included on the shim, or elsewhere within the terminal (perhaps hidden in a battery compartment), which transmits the data wirelessly to a hidden receiver.

If such a shim is used, data, including bank account or credit card numbers, as well as PIN numbers, may be intercepted and transmitted to a third party for fraudulent uses. Detecting the presence of such a shim is thus important to preserve the integrity of a card reading device, particularly a portable card reading device.

Thus, it remains a requirement in the art to provide an improved security system for credit card and payment terminals and other sensitive electronic devices, to detect the presence of a shim and disable the card reader or notify the user that security may be compromised, when a shim is detected.

### SUMMARY OF THE INVENTION

A shim designed to transmit data to a hidden receiver will naturally require electrical power, which will be delivered through the contacts in the card reader that would normally directly contact the card. The present invention detects the current flowing through the contacts of the smart card reader due to the presence of a shim. The card terminal of the present invention, named “PayPod” includes a device for accepting and connecting to a standard Smart Card. There are five active connections on the device: Power, Ground, Card clock, Card reset, and Card data.

In the present invention, small value resistors are connected in series with either the Power connection or the Ground connection, or both. Values are typically 47 milliohms to 100 milliohms. The use of such small values ensures that little voltage is dropped across the resistors and that the card is therefore adequately powered. With no card present, the current through these resistors should be zero and therefore the voltage across the resistors will also be zero. Amplifier circuits are employed to monitor and amplify the voltage across the resistors and in the “PayPod” design the amplifier outputs are connected to analogue to digital inputs on the microprocessor. Where the microprocessor (or other processing electronics) used has no analogue to digital inputs, separate analogue to digital circuits may be used. The microprocessor may then monitor the current flowing into the power supply contacts of the card reader.

If current is flowing when no card is present then the terminal will not attempt to communicate with the card. The terminal may be programmed with a “normal range” of current flow to be expected when a card is in position and NOT being “clocked” (i.e., no clock signal is supplied to the clock connection to the card). If the measured current flow is greater than the top limit of this normal range then the terminal will cease communication with the card. In addition, the terminal will be programmed with a “normal range” of current flow to be expected when a card is in position and being “clocked” (i.e., a clock signal is supplied to the clock connection to the card). If the measured current flow is greater than the top limit of this normal range then the terminal will cease communication with the card.

In the case where the current into the power connection and out of the ground connection are both monitored, any difference between the measured levels will cause the terminal to cease communication with the card. This state could come about if the installer of the shim attempts to provide an alternative connection to ground rather than using the ground pin of the card connector. Attempts to interfere with the current sensing by shorting out the sensing resistors is thwarted by setting a minimum level of measured current for the card when it is being clocked (the clock signal in a smart card is the system clock for the card electronics and is not used as a clock for synchronous data transfer and thus a card containing CMOS circuitry will only draw significant current when the clock signal is present). If the measured current when the clock signal is applied is too low the terminal will cease communication with the card. This action amounts to a test of the current sensing mechanism each time a card is inserted.

### BRIEF DESCRIPTION OF THE DRAWINGS

FIG. 1 is a diagram illustrating a smart card contact pad and a basic schematic of the apparatus of the present invention.

FIG. 2 is a diagram illustrating the steps in the shim detection process of the present invention.

FIG. 3 is a frontal view of the PayPod card terminal of the present invention.

### DETAILED DESCRIPTION OF THE INVENTION

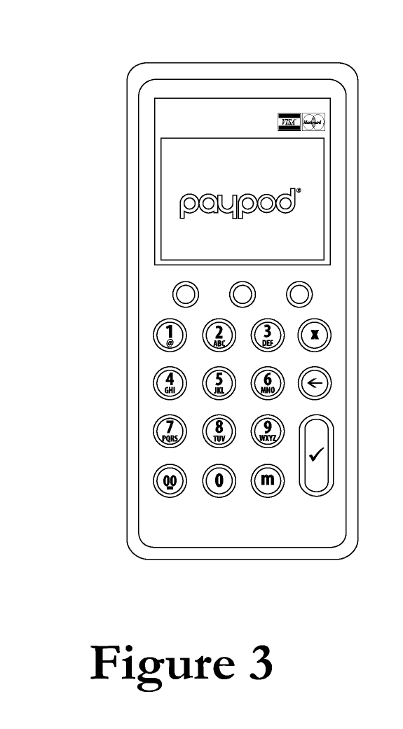

FIG. 3 is a frontal view of the PayPod card terminal of the present invention. The device includes a display, a keypad for inputting PIN numbers, payment amounts, and the like, and a card reader contact pad for accepting and connecting to a standard Smart Card. Referring to

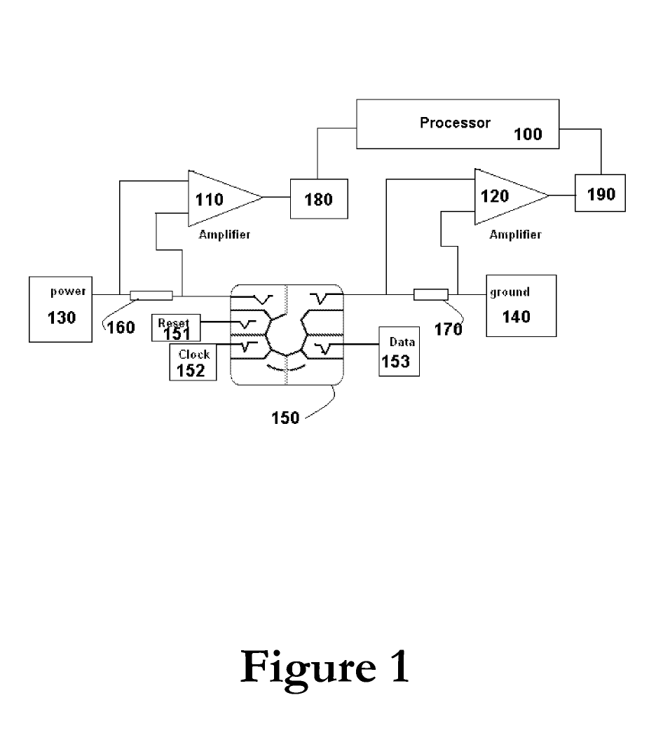

FIG. 1, illustrated therein is a contact pad 150 for a so-called “Smart Card” of the type typically used for banking and other uses in many parts of the world. As illustrated in FIG. 1, there are five active connections on the device: Power 130, Ground 140, Card clock 152, Card reset 151, and Card data 153.

As illustrated in FIG. 1, small value resistors 160 and 170 are connected in series with either the Power connection 130 or the Ground connection 140, or both. Values are typically 47 milliohms to 100 milliohms. The use of such small values ensures that little voltage is dropped across the resistors 160, 170 and that the card is therefore adequately powered. With no card present, the current through these resistors 160, 170 should be zero and therefore the voltage across the resistors 160, 170 will also be zero. Amplifier circuits 110 and 120, as illustrated in FIG. 1, are employed to monitor and amplify the voltage across the resistors 160 and 170, respectively, and in the “PayPod” design the amplifier outputs are connected to analogue to digital inputs 180, 190 on a microprocessor 100. Where the microprocessor 100 (or other processing electronics) used has no analog to digital inputs, separate analogue to digital circuits 180, 190 may be used. The microprocessor 100 may then monitor the current flowing into the power supply contacts 150 of the card reader.

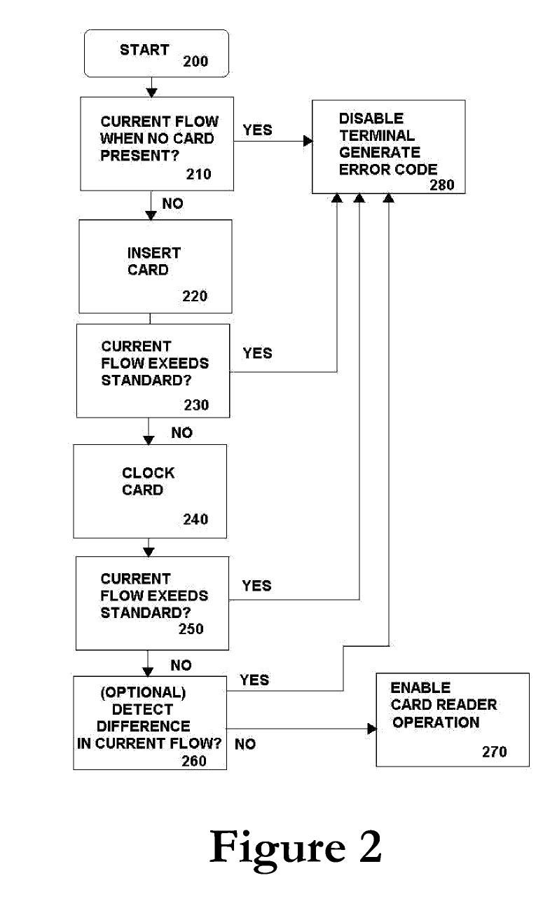

FIG. 2 is a diagram illustrating the steps in the shim detection process of the present invention. Referring to FIGS. 1 and 2, the process starts at step 200. If current is flowing when no card is present, as shown in step 210, then the terminal will not attempt to communicate with the card. The terminal may be disabled in step 280 and an error code generated or displayed, or alternately the terminal may simply refuse to communicate with any card until the condition is corrected and the device reset. The terminal may be programmed with a “normal range” of current flow to be expected when a card is in position and NOT being “clocked” (i.e., no clock signal is supplied to the clock connection to the card). Once a card is inserted into the reader in step 220, if the measured current flow is greater than the top limit of this normal range (or lower than a minimum range), as determined in step 230, then the terminal will cease communication with the card and processing passed to step 280. In addition, the terminal may be programmed with a “normal range” of current flow to be expected when a card is in position and being “clocked” (i.e., a clock signal is supplied to the clock connection to the card). In step 240, the clock is then clocked, and if the measured current flow is greater than the top limit of this clocked normal range as determined in step 250 (or lower than a minimum range) then the terminal will cease communication with the card and processing passes to step 280.

In an optional step, in the embodiment where the current into the power connection and out of the ground connection are both monitored, any difference between the measured current levels, as determined in step 260 may cause the terminal to cease communication with the card and processing passes to step 280. This state could come about if the installer of the shim attempts to provide an alternative connection to ground rather than using the ground pin of the card connector.

Attempts to interfere with the current sensing by shorting out the sensing resistors may also be thwarted by setting a minimum level of measured current for the card when it is being clocked (the clock signal in a smart card is the system clock for the card electronics and is not used as a clock for synchronous data transfer and thus a card containing CMOS circuitry will only draw significant current when the clock signal is present). Note that in step 250, if the measured current when the clock signal is applied is also too low, the terminal may cease communication with the card and processing passes to step 280. This action amounts to a test of the current sensing mechanism each time a card is inserted.

If none of these events is detected, the card reader may be enabled as illustrated in step 270. Note that for the purposes of illustration, this process is shown as a flow chart in FIG. 2. However, in actual operation, these processes may not be linear, but may occur concurrently, continually, periodically, or randomly, to insure that a shim or other device is not activated after the card has been inserted and clocked, or during a transaction or the like.

While disclosed herein in the context of a Credit Card and Payment terminal, the present invention may also be applied to any type of sensitive electronic device, where data protection and anti-tampering features are desirable. Such applications include, but are not limited to, Automated Teller Machines (ATMs), Cable and Satellite Television decoders (set-top boxes), Cellular telephones, Personal Digital Assistants, and the like.

While the preferred embodiment and various alternative embodiments of the invention have been disclosed and described in detail herein, it may be apparent to those skilled in the art that various changes in form and detail may be made therein without departing from the spirit and scope thereof.

We claim:

1. A tamper detection system for a smart card reader, comprising:
a card reader contact pad, having at least a power supply and ground contacts coupled to respective power supply and ground;
at least one resistor, placed in series with at least one of the power supply and ground contacts and a corresponding power supply and ground;
at least one amplifier, connected across the at least one resistor, for reading a voltage drop across the at least one resistor as a function of current draw and outputting a signal indicative of current draw,
a processor, for comparing the signal indicative of the current draw to a predetermined current draw amount, and detecting tampering if the current draw does not compare to the predetermined current draw amount.

2. The tamper detection system for a smart card reader of claim 1, wherein the processor compares the signal indicative of the current draw to a predetermined current draw amount when a smart card is not present in the smart card reader, and tampering is detected if the current draw exceeds the predetermined current draw amount when a smart card is not present in the smart card reader.

3. The tamper detection system for a smart card reader of claim 1,
wherein the card reader contact pad further includes a clock contact for transmitting a clock signal from the smart card reader to a smart card,
where a smart card is inserted in the smart card reader but is unclocked, and
where the processor compares the signal indicative of the current draw to a predetermined maximum current draw for an unclocked smart card, and tampering is detected if the current draw exceeds the predetermined maximum current draw for an unclocked smart card.

4. The tamper detection system for a smart card reader of claim 1,
wherein the card reader contact pad further includes a clock contact for transmitting a clock signal from the smart card reader to a smart card,
where a smart card is inserted in the smart card reader and is clocked, and
wherein the processor compares the signal indicative of the current draw to a predetermined maximum current draw for a clocked smart card, and tampering is detected if the current draw exceeds the predetermined maximum current draw for a clocked smart card.

5. The tamper detection system for a smart card reader of claim 1,
wherein the card reader contact pad further includes a clock contact for transmitting a clock signal from the smart card reader to a smart card,
where a smart card is inserted in the smart card reader and is clocked, and
wherein the processor compares the signal indicative of the current draw to a predetermined minimum current draw for a clocked smart card, and tampering is detected if the current draw is lower than a predetermined minimum current draw for a clocked smart card.

6. The tamper detection system for a smart card reader of claim 1,
wherein the at least one resistor comprises:
a first resistor, placed in series between the power supply contact and the power supply and ground, and
a second resistor, placed in series with the ground contact and ground; and
wherein the at least one amplifier comprises:
a first amplifier connected across the first resistor, for reading a voltage drop across the first resistor as a function of current through the first resistor and outputting a first signal indicative of current through the first resistor, and
a second amplifier connected across the second resistor, for reading a voltage drop across the second resistor as a function of current through the second resistor and outputting a second signal indicative of current through the second resistor,
wherein the processor compares the first signal to the second signal to compare current through the first resistor to current through the second resistor, and tampering is detected if the current through the first resistor is not substantially equal to current through the second resistor.

7. The tamper detection system for a smart card reader of claim 1, wherein if tampering is detected, the processor ceases communication with an inserted smart card.

8. A method of detecting tampering in a smart card reader comprising a card reader contact pad, having at least a power supply and ground contacts coupled to respective power supply and ground, at least one resistor, placed in series with at least one of the power supply and ground contacts and a corresponding power supply and ground, at least one amplifier, connected across the at least one resistor, for reading a voltage drop across the at least one resistor as a function of current draw and outputting a signal indicative of current draw, and a processor coupled to the at least one amplifier for receiving the signal indicative of current draw, the method comprising the steps of:
measuring current passing through the at least one resistor, using the at least one amplifier to measure a voltage drop across the at least one resistor and outputting a signal indicative of current passing through the at least one resistor,
comparing, in the processor, the signal indicative of the current draw to a predetermined current draw amount, and
detecting tampering if the current draw does not compare to the predetermined current draw amount.

9. The method of detecting tampering in a smart card reader of claim 8, wherein the step of comparing comprises the step of comparing in the processor, the signal indicative of the current draw to a predetermined current draw amount when a smart card is not present in the smart card reader, and
the step of detecting comprises detecting tampering if the current draw exceeds the predetermined current draw amount when a smart card is not present in the smart card reader.

10. The method of detecting tampering in a smart card reader of claim 8, wherein the card reader contact pad further includes a clock contact for transmitting a clock signal from the smart card reader to a smart card, the method further comprising the steps of:
inserting a smart in the smart card reader without clocking the smart card,
wherein the comparing step further comprises the step of comparing, in the processor, the signal indicative of the current draw to a predetermined maximum current draw for an unclocked smart card, and
wherein the step of detecting comprises the step of detecting tampering if the current draw exceeds the predetermined maximum current draw for an unclocked smart card.

11. The method of detecting tampering in a smart card reader of claim 8, wherein the card reader contact pad further includes a clock contact for transmitting a clock signal from the smart card reader to a smart card, the method further comprising the steps of:
inserting a smart card in the smart card reader,
clocking the smart card inserted in the smart card reader,
wherein the comparing step further comprises the step of comparing the signal indicative of the current draw to a predetermined maximum current draw for a clocked smart card, and
wherein the step of detecting comprises the step of detecting tampering if the current draw exceeds the predetermined maximum current draw for a clocked smart card.

12. The method of detecting tampering in a smart card reader of claim 8, wherein the card reader contact pad further includes a clock contact for transmitting a clock signal from the smart card reader to a smart card, the method further comprising the steps of:
inserting a smart card in the smart card reader,
clocking the smart card inserted in the smart card reader,
wherein the comparing step further comprises the step of comparing the signal indicative of the current draw to a predetermined minimum current draw for a clocked smart card, and
wherein the step of detecting further comprises the step of detecting tampering if the current draw is lower than the predetermined minimum current draw for a clocked smart card.

13. The method of detecting tampering in a smart card reader of claim 9, wherein the at least one resistor comprises a first resistor, placed in series between the power supply contact and the power supply and ground, and a second resistor, placed in series with the ground contact and ground, and wherein the at least one amplifier comprises a first amplifier connected across the first resistor, for reading a voltage drop across the first resistor as a function of current through the first resistor and outputting a first signal indicative of current through the first resistor, and a second amplifier connected across the second resistor, for reading a voltage drop across the second resistor as a function of current through the second resistor and outputting a second signal indicative of current through the second resistor, the method further comprising the steps of:
wherein the step of measuring current further comprises the steps of:
measuring current passing through the first resistor, using the first amplifier to measure a voltage drop across the first resistor and outputting a signal indicative of current passing through the first resistor, and
measuring current passing through the second resistor, using the first amplifier to measure a voltage drop across the second resistor and outputting a signal indicative of current passing through the second resistor,
wherein the step of comparing comprises the step of comparing, in the processor, the first signal to the second signal to compare current through the first resistor to current through the second resistor, and
wherein the step of detecting further comprises the step of detecting tampering if the current through the first resistor is not substantially equal to current through the second resistor.

14. The method of detecting tampering in a smart card reader of claim 8, wherein if tampering is detected, the processor ceases communication with an inserted smart card.

15. A portable smart card reader terminal having a tamper detection system, comprising:
a portable smart card reader terminal housing;
a keypad, mounted to the housing, for receiving input data from a user, including a PIN number;
a display, mounted to the housing, for displaying data;
a card reader contact pad, mounted to the housing, having at least a power supply and ground contacts coupled to respective power supply and ground;
at least one resistor, placed in series with at least one of the power supply and ground contacts and a corresponding power supply and ground;
at least one amplifier, connected across the at least one resistor, for reading a voltage drop across the at least one resistor as a function of current draw and outputting a signal indicative of current draw,
a processor, for comparing the signal indicative of the current draw to a predetermined current draw amount, and detecting tampering if the current draw does not compare to the predetermined current draw amount.

16. The portable smart card reader terminal having a tamper detection system of claim 15, wherein the processor compares the signal indicative of the current draw to a predetermined current draw amount when a smart card is not present in the smart card reader, and tampering is detected if the current draw exceeds the predetermined current draw amount when a smart card is not present in the smart card reader.

17. The portable smart card reader terminal having a tamper detection system of claim 15,
wherein the card reader contact pad further includes a clock contact for transmitting a clock signal from the smart card reader to a smart card,
where a smart card is inserted in the smart card reader but is unclocked, and
where the processor compares the signal indicative of the current draw to a predetermined maximum current draw for an unclocked smart card, and tampering is detected if the current draw exceeds the predetermined maximum current draw for an unclocked smart card.

18. The portable smart card reader terminal having a tamper detection system of claim 15,
wherein the card reader contact pad further includes a clock contact for transmitting a clock signal from the smart card reader to a smart card,
where a smart card is inserted in the smart card reader and is clocked, and
wherein the processor compares the signal indicative of the current draw to a predetermined maximum current draw for a clocked smart card, and tampering is detected if the current draw exceeds the predetermined maximum current draw for a clocked smart card.

19. The portable smart card reader terminal having a tamper detection system of claim 15,
wherein the card reader contact pad further includes a clock contact for transmitting a clock signal from the smart card reader to a smart card,
where a smart card is inserted in the smart card reader and is clocked, and
wherein the processor compares the signal indicative of the current draw to a predetermined minimum current draw for a clocked smart card, and tampering is detected if the current draw is lower than a predetermined minimum current draw for a clocked smart card.

20. The portable smart card reader terminal having a tamper detection system of claim 15,
wherein the at least one resistor comprises:
a first resistor, placed in series between the power supply contact and the power supply and ground, and
a second resistor, placed in series with the ground contact and ground; and
wherein the at least one amplifier comprises:
a first amplifier connected across the first resistor, for reading a voltage drop across the first resistor as a function of current through the first resistor and outputting a first signal indicative of current through the first resistor, and
a second amplifier connected across the second resistor, for reading a voltage drop across the second resistor as a function of current through the second resistor and outputting a second signal indicative of current through the second resistor,
wherein the processor compares the first signal to the second signal to compare current through the first resistor to current through the second resistor, and tampering is detected if the current through the first resistor is not substantially equal to current through the second resistor.

21. The portable smart card reader terminal having a tamper detection system of claim 15, wherein if tampering is detected, the processor ceases communication with an inserted smart card.
